(19) United States
(12) Patent Application Publication
(10) Pub. No.: US 2021/0114167 A1
(43) Pub. Date: Apr. 22, 2021

(54) Grinding and/or Eroding Machine, and Method for Measuring and/or Referencing the Machine

(71) Applicant: Walter Maschinenbau GmbH, Tübingen (DE)

(72) Inventors: Siegfried Hegele, Dusslingen (DE); Steffen Schnaible, Böblingen (DE)

(21) Appl. No.: 16/611,978

(22) PCT Filed: May 4, 2018
(86) PCT No.: PCT/EP2018/061579

§ 371 Date: Nov. 8, 2019

(30) Foreign Application Priority Data
May 11, 2017 (DE) 10 2017 110 198.5

(51) Int. Cl. B24B 47/22; G05B 19/401

(52) U.S. Cl. CPC B24B 47/22; G05B 2219/45161; G05B 2219/37008; G05B 19/401

(57) ABSTRACT

The invention relates to a grinding and/or erosion machine (10), as well as to a method for gauging and referencing the axis arrangement (11) comprising several machine axes (12), wherein each can be configured as a rotational or translational machine axis. To do so, a measuring disk (28) is inserted in a tool spindle (13) and a test mandrel (27) is inserted in a workpiece holding device (14). The test mandrel (27) is electrically connected to a reference potential, preferably ground (M). The measuring disk (28) is electrically connected to a supply voltage potential (UV). By forming a contact between the measuring disk (28) and the test mandrel (27), a measuring current (IM) flows between the supply voltage potential (UV) and the reference potential and, in accordance with the example, from the supply voltage potential (UV) to ground (M). The flow of this measuring current (IM) may be detected in a monitoring device (31), and the actual position of the machine axes (12) at the time of the start of the current flow of the measuring current (IM) can be determined. Via the axis arrangement (11), one or more contact locations (K) between the measuring disk (28) and the test mandrel (27) can be approached, and, as a result of this, referencing or gauging of the axis arrangement (11) and the machine, respectively, can take place.

The invention relates to a grinding and/or erosion machine, as well as to a method for gauging and referencing of the machine, respectively.

A grinding and/or erosion machine comprises several machine axes to allow moving and positioning of a workpiece to be processed relative to a tool. For precise machining it is necessary to know the position of the machine axes relative to a stationary coordinate system of the machine base or the machine frame.

Publication DE 10 2008 004 849 B4 suggests that a multi-axis referencing sensor arrangement be provided in order to perform, during interruptions, a referencing procedure with the components used for machining and the translational, as well as rotational, axes, in that the relative position between a workpiece holding device and a workpiece is determined in several dimensions. To do so, the multi-axis referencing sensor arrangement comprises respectively one reference sensor for each spatial direction, in which case said reference sensor may be configured as a contact sensor or as a proximity sensor.

With the use of contact sensors or force sensors it must be ensured that the force with which the tool or workpiece is pressed against the respective reference sensor can be adjusted very precisely. The demands in view of accuracy and consistency of the sensors are thus extremely high. If proximity sensors are used, these must be adjusted highly accurately in order to set the location at which the approaching element is detected. All sensor types must display high detection accuracy with minimal tolerance. Furthermore, the use of contact, force or proximity sensors in machine tools is frequently fraught with problems because they are exposed to contamination by chips, cooling fluids or the like.

Therefore, the object of the present invention may be viewed to be the provision of a grinding and/or erosion machine, as well as of a method, for gauging or referencing the machine, said gauging and referencing providing high accuracy with simple means.

This object is achieved with a grinding and/or erosion machine displaying the features of Patent Claim 1, as well as with a method displaying the features of Patent Claim 16.

According to the invention the grinding and/or erosion machine comprises a tool spindle that can be driven about a spindle axis in which a grinding or erosion tool can be arranged. A workpiece holding device is provided for a workpiece that is to be machined. The machine comprises a machine axis arrangement with several machine axes. Each machine axis may be configured as a rotational or translational machine axis. Up to six machine axes may be provided, each being disposed to position or move the tool spindle, or a tool provided there, relative to the workpiece holding device or a workpiece that is arranged there, in order to be able to perform the desired process. The position of each of the existing machine axes is detected by a position detecting device. To accomplish this, the position detecting device may comprise position sensors that measure the position within the respective translational or rotational degree of freedom. It is also possible for the position detecting device to determine the position of a machine axis based on other parameters that are characteristic of the respective position. Therefore, it is possible that the position detection occurs either based on directly measured actual position values or based on indirect parameters describing this actual position.

Electrically conductive measuring bodies, preferably an electrically conductive test mandrel, as well as an electrically conductive measuring disk, are used for gauging or referencing. The one, first, measuring body, in particular the test mandrel, may be arranged in the workpiece holding device and the respectively other, second, measuring body, in particular the measuring disk, may be arranged in the tool spindle. For gauging or referencing, the second measuring body is connected to a supply voltage potential so that, on the second measuring body, a voltage is applied, said voltage preferably corresponding to the supply voltage potential. The first measuring body that is arranged in the workpiece holding device is electrically connected to a defined reference potential that is lower than the supply voltage potential. The reference potential preferably acts as a ground potential (0 Volt). Furthermore, the second measuring body is connected to a monitoring device.

Via a control device, it is possible to move or position or align the measuring bodies relative to each other. The control device of the machine controls the machine axes in order to move the measuring bodies toward each other in a relative manner such that they come into contact with each other at a contact location. As soon as this contact occurs at the contact location, a measuring current flows between the measuring bodies and, preferably, from the second measuring body with higher potential to the first measuring body with lower potential. This measuring current is detected by the monitoring device that is connected to the second measuring body. As soon as the measuring current is detected, the actual position of the at least one drive machine axis, or all machine axes, is stored in memory. Therefore, due to the contact between the two measuring bodies, a reference position can be determined at the contact location. The determination of this reference position may be highly exact. It has been found that the measuring current can be detected with great accuracy directly after a contact between the measuring bodies. At this time, the appropriate actual position can be detected and stored, respectively as the reference position. Differences due to varying contact pressure forces between the measuring bodies do not occur.

The machine and the method, respectively, do not require expensive or elaborate sensor systems. The detecting of the measuring current may occur outside the operational range of the machine. Sensitive sensors are not needed within the operational range of the machine. Consequently, referencing and gauging, respectively, may take place with simple, cost-effective means with simultaneous high accuracy.

Preferably, driving of the at least one driven machine axis is stopped as soon as a contact between the measuring bodies has been detected. Consequently, high contact pressure forces between the measuring bodies are avoided.

It is advantageous if—for gauging and referencing, respectively—a sequence of contact locations is successively approached. For example, at least two, three or more contact locations per sequence may exist in order to perform a specific measurement or compare the orientation between machine axes with each other. In doing so, an orientation for one or more rotational machine axes may be specified for the at least one contact location. The approach movement directly prior to and up to contact between the measuring bodies occurs preferably with a single, in particular translational, machine axis.

In a preferred exemplary embodiment, the second measuring body may be configured as a measuring disk that has a circumferential surface that is closed in a ring-shaped manner and a lateral surface, wherein the circumferential surface encloses the lateral surface, adjoining said surface. For example, the measuring disk may be disk that is contoured in the form of a circle. In conjunction with this, it is possible that the measuring disk contacts the other, first measuring body having the circumferential surface or the lateral surface at the contact location. This depends on where the contact location on the first measuring body, for example the test mandrel, is arranged and which machine axes are used for the relative movement until this contact location is reached.

For gauging and referencing, respectively, of all machine axes of the grinding and/or erosion machine, the number of contact locations in a sequence that are successively approached preferably corresponds to the number of those machine axes that are disposed to change the relative position between the measuring bodies. In so doing, one machine axis is not taken into consideration, namely the one that can effect a rotation of the first measuring body about its longitudinal axis.

In a preferred exemplary embodiment, the monitoring device comprises a monitoring unit. The monitoring unit may be a component of the control device or be communicationally connected to the control device.

Preferably, the monitoring unit is disposed to monitor whether or not the second measuring body is electrically connected to the supply voltage potential. A corresponding monitoring result can be transmitted to the control device or be made available to the control device in another suitable manner. The control device can switch into a safety operation mode if the monitoring device determines that the electrical connection between the second measuring body and the supply voltage potential has been effected. As a result of this, it has been recognized, so to speak, that no workpiece machining but a gauging and referencing, respectively, are to be performed. Subsequently, the safety operation mode is activated and the control device controls the machine axis arrangement maintaining at least one restriction of the safety operation mode.

In safety operation mode, it is possible, for example, to prevent the operation of the tool spindle, so that the second measuring body is prevented from rotating about the spindle axis. Alternatively or additionally, the driving force or a driving torque of one or more machine axes may be limited to a maximum force or a maximum torque. Therefore, damage to the measuring bodies due to great contact pressure forces can be avoided. To do so, it is possible, for example, to subject an electric motor belonging to the respective machine axis and representing its drive to a torque limit, for example by appropriate limitation of the motor current. In order to limit the force or torque of the respective machine axis, it is possible, for example, for a measurement and limitation of the motor current to occur.

It is advantageous if the second measuring body is electrically connected via a connecting line to a first contact of electrical connecting component. Furthermore, the electrical connecting component may comprise a second contact and a third contact that can be short-circuited with each other.

An electrical counter-connecting component may be provided for the electrical connection to the connecting component. The counter-connecting component comprises a first counter contact that is connected to the supply voltage potential by means of a first conductor via the monitoring device. A monitoring component of the monitoring device may be arranged in this first conductor, said device providing a switching function, for example a transistor, a relay, and optical coupler or the like. Preferably, the monitoring component may additionally provide a galvanic isolation of the first conductor from a measuring circuit.

Furthermore, it is advantageous if the counter-connecting component has a second counter contact that is connected to the supply voltage potential by means of a second conductor. Additionally, an optional third counter contact may be provided that is connected, by means of a third conductor, to the monitoring device and, in particular, to the monitoring unit of the monitoring device.

With the connected established between the connecting component and the counter-connecting component, an electrical connection is effected between the first contact and the first counter contact. If present, there is also effected an electrical connection between the second contact and the counter contact and/or between the third contact and the third counter contact. Due to the short circuit between the second contact and the third contact, thus—with the connection between the connecting component and the counter-connecting component established—an electrical connection is effected between the supply voltage potential and the monitoring device and the monitoring unit, respectively. In this manner, it is possible to detect the connection of the second measuring body to the supply voltage potential and, for example, activate the safety operation mode.

Advantageous embodiments of the invention can be inferred from the dependent patent claims, the description and the drawings. Hereinafter, preferred exemplary embodiments of the invention are explained in detail with reference to the appended drawings. They show in

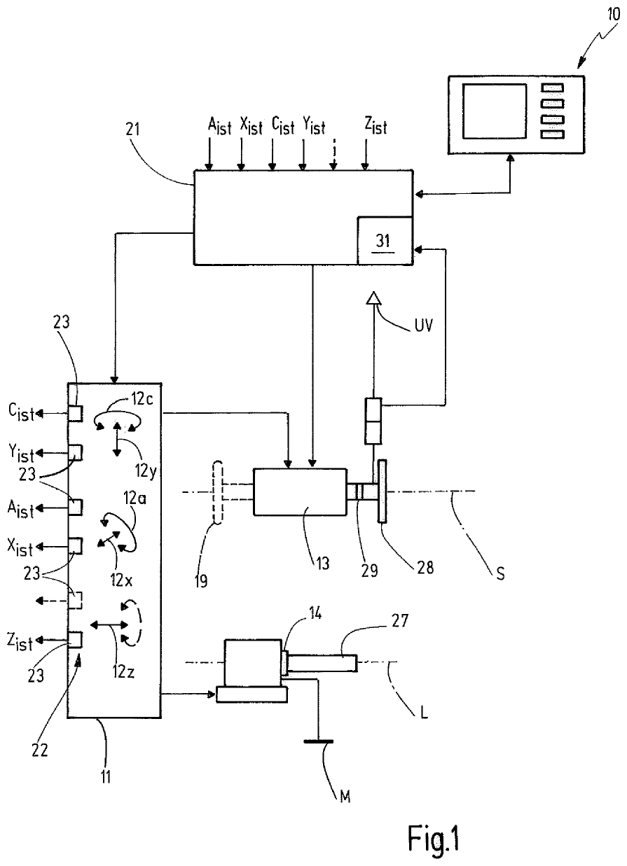

FIG. 1 a schematic, block diagram-like representation of an exemplary embodiment of a grinding and/or erosion machine,

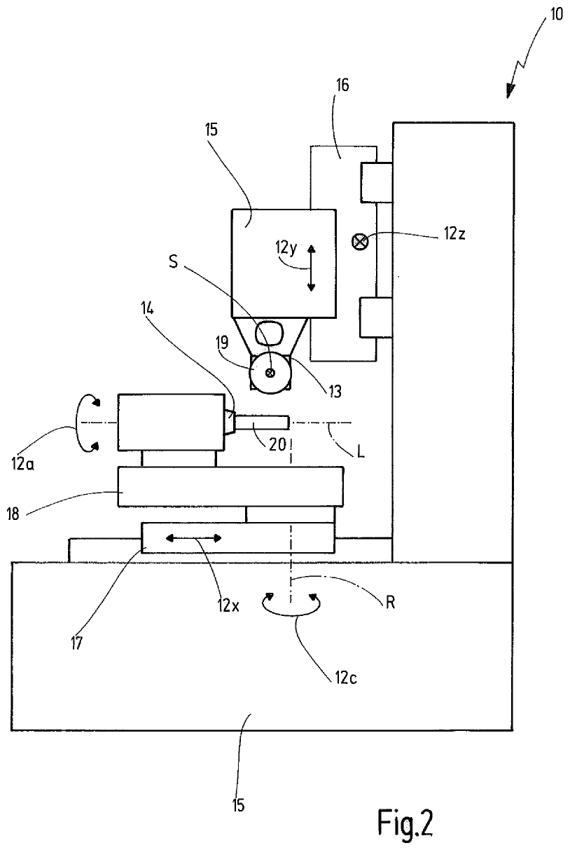

FIG. 2 a schematic side elevation of an exemplary embodiment of a grinding and/or erosion machine according to the block diagram of FIG. 1,

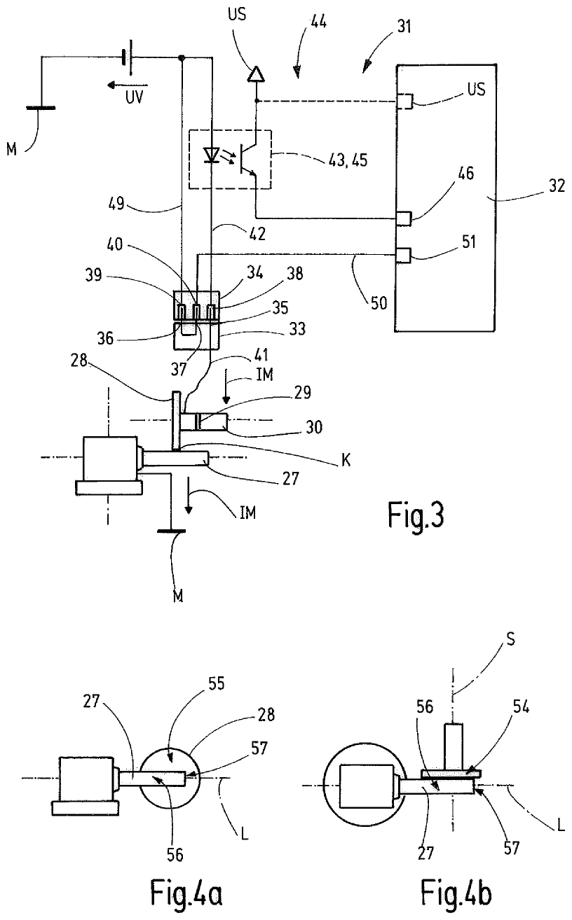

FIG. 3 a basic diagram of an exemplary embodiment of the electrical connection of a measuring disk to a supply voltage potential and a monitoring device, as well as the electrical connection of a test mandrel to a reference potential,

FIGS. 4 to 7 a schematic diagram, in side elevation (Figure a), and a plan view (respectively Figure b) of the test mandrel and the measuring disk of FIGS. 1 to 3, with different contact locations.

FIGS. 1 and 2 show an exemplary embodiment of a grinding and/or erosion machine 10 in a greatly simplified manner. The grinding and/or erosion machine 10 comprises a machine axis arrangement 11 that comprises at least one, and preferably several, translational and/or rotational machine axes 12. In the exemplary embodiment illustrated here the axis arrangement 11 comprises three translational axes, namely an X-axis 12x, a Y-axis 12y, as well as a Z-axis 12z. Furthermore, the machine axis arrangement 11, in accordance with the example, comprises two rotational machine axes, namely an A-axis 12a and a C-axis 12c. Via the C-axis 12c, it is possible to perform a rotation about an axis of rotation R that extends parallel to y-direction and Y-axis 12y, respectively. By means of the A-axis it is possible to perform a rotation about an axis that extends parallel to the x-direction and the X-axis 12x, respectively. Optionally, there may be present a rotational axis with which a rotation about an axis of rotation may be performed, said axis extending parallel to the z-direction and the Z-axis 12z, respectively. Referring to the exemplary embodiment shown by FIG. 2, only five machine axes 12 are provided, namely three translational machine axes 12x, 12y, 12z, as well as the two rotational machine axes 12a and 12c.

By means of the machine axis arrangement 11 it is possible to move a tool spindle 13 and/or a tool holding device 14 relative to a machine base 15, so that also a relative movement between the tool spindle 13 and the workpiece holding device 14 can be achieved. In doing so, different axis configurations can be used. For moving the tool spindle 13, it is possible to use one or more translational or rotational machine axes 12 and for moving the workpiece holding device 14, it is accordingly possibly to move other translational or rotational machine axes 12. Referring to the exemplary embodiment shown by FIG. 2, the Y-axis 12y and the Z-axis 12z can be used for moving the tool spindle 13, while the X-axis 12x and the C-axis 12c can be used for moving the workpiece holding device 14. The A-axis 12a is disposed to drive the workpiece holding device 14 about its longitudinal axis L.

The machine axes 12 of the axis arrangement 11 are indicated only symbolically in FIG. 1 and only by their schematically indicated axes of rotation or slides in FIG. 2. The tool spindle 13 is seated on a first slide 15 that can be moved by means of the Y-axis 12y relative to a second slide 16. The second slide 16 bearing the first slide 15 can be moved by means of the Z-axis 12z relative to the machine base 15. A third slide 17 is arranged on the machine base 15 so as to be movable via the X-axis 12x and bears the C-axis 12c. By means of the C-axis 12c, it is possible to perform a rotation of the carrier 18 about an axis of rotation R. In turn, the Z-axis 12a and the workpiece holding device 14 are seated on the carrier 18, in which case the A-axis 12a is able to drive the workpiece holding device 14 about the longitudinal axis L.

Consequently, it is possible, by means of the machine axis arrangement 11, to align and position, respectively, the tool spindle 13 relative to the workpiece holding device 14. The tool spindle 13 is disposed for accepting a tool 19, for example a grinding tool and/or an erosion tool. By means of the tool spindle 13, it is possible drive a tool 19, for example a grinding disk so as to be driven in a rotating manner about the spindle axis S. The tool spindle 13 or the associate spindle drive (not illustrated) is activated by a control device 21 that can specify a desired rate of revolutions.

The workpiece holding device 14 is disposed for accepting and clamping, respectively, a workpiece 20. The workpiece 20 can be rotated or pivoted by means of the A-axis 12a about its longitudinal axis L or by means of the C-axis 12c about the axis of rotation R. Due to a pivoting movement about the axis of rotation R by means of the C-axis 12c, the angle between the longitudinal axis L and the spindle axis S are adjusted. In accordance with the example, this angle may be varied between 0° and 180°.

Via the control device 21, the machine axis arrangement 11 is also activated in such a manner that each machine axis 12 can be driven individually. The position of each machine axis 12 is detected by a position detecting device 22. In so doing, each machine axis 12 may be associated with a position sensor 23 in order to detect the respective position value Aᵢₛₜ, Cᵢₛₜ, Xᵢₛₜ, Yᵢₛₜ, Zᵢₛₜ (“ist” [sic.]=actual) and transmit it to the control device 21. If there is an additional rotational axis, a corresponding actual value can be transmitted by the position detecting device 22 to the control device 21, this being illustrated in dashed lines in FIG. 1.

As an alternative to the suggested embodiment, the position detection may also be accomplished by the position detecting device 22 on the basis of other values that are characteristic of the respective actual position. Then, a direct measurement of the actual position values is not necessary.

In accordance with the example, the grinding and/or erosion machine 10 is disposed for performing a method for gauging or referencing the machine axes 12. To do so, instead of a workpiece, an electrically conductive first measuring body—according to the example a test mandrel 27—can be inserted in the workpiece holding device 14. Furthermore, instead of a tool 19, an electrically conductive second measuring body—according to the example a measuring disk 28—can be inserted in the tool spindle 13. The test mandrel 27 is electrically connected to a fixed reference potentials and, according to the example, electrically connected to ground M. The connection may be achieved directly—via a line—on the test mandrel 27 or indirectly via the workpiece holding device 14.

The measuring disk 27 is electrically connected to a supply voltage potential UV. Via an electrical isolation 29, a shaft section 30 of the shaft connected to the measuring disk 28 is electrically isolated relative to the measuring disk 28. Via the shaft section 30, the measuring disk 28 is accommodated in the tool spindle 13. The supply voltage potential UV applied to the measuring disk 28 thus is not applied to the tool spindle 13, and a current flow in or across the tool spindle 13 is prevented by the electrical isolation 29.

Furthermore, the measuring disk 28 is electrically connected to a monitoring device 31. The monitoring device 31 comprises a monitoring unit 32. The monitoring device 31 or at least the monitoring unit 32 may be a component of the control device 21 or may be communicationally connected to the control device 21. The electrical connection between the monitoring device 31 and the measuring disk 28 occurs via a connecting device with a connecting component 33 and a counter-connecting component 34. The connecting component 33 is preferably configured as a plug and the counter-connecting component 34 as a socket. For example, the counter-connecting component 34 can be attached to the grinding and/or erosion machine 10 in the region of the tool spindle 13, for example to the first slide 15 or a carrier for the tool spindle 13 connected to the carrier of the first slide 15.

In the exemplary embodiment, the connecting portal 33 has a first electrical contact 35 and, in accordance with the example, additionally a second electrical contact 36 and a third electrical contact 37. The electrical contacts 35, 36, 37 may be configured as plug pins. As can be inferred from FIG. 3, the second contact 36 and the third contact 37 are electrically short-circuited by the connecting component 33 and in the connecting component 33, respectively.

The counter contact component 34 has at least one first electrical counter contact 38. In the exemplary embodiment there are, additionally, a second electrical counter contact 39 and a third electrical counter contact 40. The counter contacts 38, 39, 40 may be configured as sockets for receiving a respectively associate plug pin.

Via a connecting line 41, the first electrical contact 35 is electrically connected to the measuring disk 28. The connecting line 41 is a flexible line, for example a helix cable.

The first counter contact 38 is connected to the monitoring device 31 by means of a first conductor 42. In the exemplary embodiment, the first conductor 42 is electrically connected to the supply voltage potential UV via a monitoring component 43. The monitoring component 43 has an electrical switching function and is disposed to trigger an electrical switching operation when the measuring current IM flows through the first conductor 42. This electrical switching operation is detected by the monitoring unit 32 that is electrically connected to the monitoring component 43.

In the exemplary embodiment described herein, the monitoring component 43 furthermore provides a galvanic isolation. The primary side of the monitoring component 43 is switched in the first conductor 42 when the secondary side of the monitoring component 43 is arranged in a secondary circuit 44.

In the exemplary embodiment, the monitoring component 43 is an optical coupler 45. An optical coupler diode is electrically connected, on the anode side, to the supply voltage potential UV and, on the cathode side, to the first counter contact 38. An optical coupler transistor is electrically connected, on the collector side, to a secondary voltage potential US and, on the emitter side, to a first monitoring input 46. As soon as a measuring current IM flows through the first conductor 42 and thus the optical coupler diode, the optical coupler transistor becomes conductive and electrically connects the first monitoring input 46 to the secondary voltage potential US. If, however, no measuring current IM flows through the optical coupler diode, the optical coupler transistor blocks, and the secondary voltage potential US is electrically disconnected from the first monitoring input 46. Due to the switching operation of the optical coupler transistor, it is thus possible to detect the presence of a measuring current IM in the first conductor 42.

The secondary circuit 44 may also be differently electrically configured with the aid of the monitoring component 43 or the optical coupler 45. For example, the first monitoring input 46 may be connected directly to the secondary voltage potential US and to the collector of the optical coupler transistor. The emitter of the optical coupler transistor can then be connected—via a resistor—to a potential that is low compared to the secondary voltage potential US, for example a secondary ground potential. In this case, the secondary ground potential is applied to the first monitoring input 46 when a measuring current IM flows on the primary side through the second conductor 42, while the optical coupler transistor blocks otherwise and the secondary voltage potential US is applied to the first monitoring input 46.

Additional modifications of the monitoring device 31 and the secondary circuit 44, respectively, are also possible. Instead of the optical coupler 45 it is possible to use a relay or another monitoring component 43 causing a switching operation, said component potentially being provided with or without a galvanic isolation.

The second counter contact 39 is electrically connected to the supply voltage potential UV via a second conductor 49, preferably directly connected. The third counter contact 40 is electrically connected to a second monitoring input 51 via a third conductor 50, preferably directly.

If an electrical and preferably also a mechanical connection is established between the connecting component 33 and the counter-connecting component 34, respectively one electrical connection between the first contact 35 and the first counter contact 38, between the second contact 36 and the second counter contact 39, and between the third contact 37 and the third counter contact 40 is performed. Due to the short circuit connection between the second and the third contacts 36, 37, the first conductor 49 is electrically connected to the third conductor 50, as a result of which the supply voltage potential UV is applied to the second monitoring input 51. The monitoring device 31 of the monitoring unit 32 can detect, via the second monitoring input 51, that an electrical connection was made between the connecting component 33 and the counter-connecting component 34.

Preferably, the monitoring unit 32 is disposed to generate an appropriate signal when an electrical connection between the connecting component 33 and the counter-connecting component 34 has been detected and to provide said signal to the control device 21. Then, the latter operates the grinding and/or erosion machine 10 in a safety operation mode. In safety operation mode, a driving of the tool spindle 13 about the spindle axis S and/or a rotation of the test mandrel 27 about the longitudinal axis L are prevented. A measuring disk 28 inserted in the tool spindle 13 can be prevented from rotating as a result of this.

Alternatively or additionally, one or more machine axes 12 may be operated in safety operation mode, while a force or a torque are limited. As a result of this it is prevented that excessive forces or torques act on the measuring disk 28 or the test mandrel 27 when these measuring bodies 27, 28 come into contact with each other or with another component of the grinding and/or erosion machine 10. To do so, it is possible, for example, to limit the driving torque of an involved electric motor of the respective machine axis 12, for example, by an appropriate current limitation of the motor current.

When the measuring disk 28 and test mandrel 27 are moved relative to each other via the machine axis arrangement 11 and come into contact with each other at a contact location K, an electrically conductive connection is formed between the measuring disk 28 and the test mandrel 27. Due to the potential differences between the supply voltage potential UV applied to the measuring disk 28 and the reference potential (ground M) applied to the test mandrel 28, a measuring current IM flows—in accordance with the example—from the measuring disk 28 across the test mandrel 27 and on to ground M. This current flow causes the monitoring component 43 to switch, so that the monitoring device 31 can detect the current flow of the measuring current IM. At this time, a current position of the respective machine axis that is detected via the position detecting device 22 is stored or registered otherwise.

This arrangement is capable—without the use of contact sensors or proximity sensors inside the working range of the grinding and/or erosion machine 10—to quickly and exactly detect a contact between the measuring disk 28 and the test mandrel 27.

In particular, the control device 21 is disposed to move the measuring disk 28 into contact with the test mandrel 27 on a specified sequence of contact locations. Preferably, the measuring disk 28 has a circumferential surface 54 that forms the edge of the measuring disk 28 and delimits its contour. The circumferential surface 54 encloses a lateral surface 55 that faces away from the shaft section 30. The measuring disk 28 can be brought into contact—either with its lateral surface 55 or the circumferential surface 54—with the test mandrel 27.

Each of FIGS. 4 to 7 schematically shows the approaching of a contact location in a specified alignment between the longitudinal axis L and the spindle axis S. For gauging or referencing of the grinding and/or erosion machine it is possible to approach a sequence of several contact locations K on the test mandrel 27 and to bring the measuring disk 28 into contact with the test mandrel 27 there. To do so, contact may be accomplished with the lateral surface 55 or with the circumferential surface 54 on the measuring disk 28. The contact location K may be provided on the generated surface 56 or the face 57 of the test mandrel 27.

The number of contact locations K corresponds to the number of machine axes 12 that are disposed to move the measuring disk 28 relative to the test mandrel 27. In accordance with the example, these are four machine axes because the A-axis 12a can cause a rotation of the test mandrel 27 about its longitudinal axis L, which, however, does not change the relative position between the measuring disk 28 and the test mandrel 27. Consequently, the test mandrel 27 is approached—corresponding to the three translational axes 12x, 12y and 12z—on three different contact locations K in a first position of the C-axis at a specified angle of rotation about the axis of rotation R. In addition, at least one contact location K is approached under another position of rotation of the C-axis 12c about the axis of rotation R. For example, the two positions of rotation around the axis of rotation R may differ by 90° from each other.

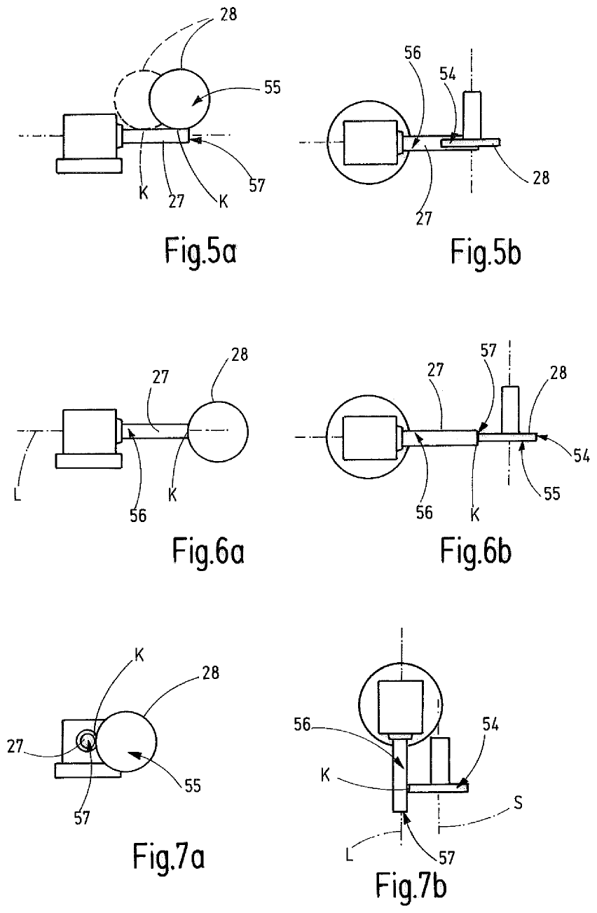

In the exemplary embodiment, the longitudinal axis L may initially be aligned in x-direction (FIGS. 4 to 6). In this alignment of the test mandrel 27, the measuring disk 28 is moved with the use of the Y-axis 12y at a first contact location with the lateral surface 55 against the generated surface 56, and the position of this first contact location is detected (FIGS. 4a and 4b). Subsequently, with the use of the Z-axis 12z, the circumferential surface 54 of the measuring disk 28 is moved against the generated surface 56 of the test mandrel 27 on at least one additional contact location K, and the position is detected (FIGS. 5a and 5b). Finally, another contact location K on the face 57 of the test mandrel 27 is approached, in which case the X-axis 12x is used, and the relative movement in this case takes place via a movement of the test mandrel 27 toward the measuring disk 28. With the detection of these three contact locations, it is possible to determine the relative position of the translational axes relative to the longitudinal axis L and the spindle axis S. In order to reference the rotational C-axis 12c, a rotation of the C-axis by a specified angle of rotation about the axis of rotation R, for example 90°, is performed and, subsequently, a contact is established between the test mandrel 27 and the measuring disk 28 with the use of at least one of the translational axes 12x, 12y, 12z. In the exemplary embodiment shown by FIGS. 7a and 7b, this relative movement is accomplished by X-axis 12x. In this pivoted position of the C-axis, it is possible to approach further additional contact locations and to determine the corresponding position.

With the aid of the described grinding and/or erosion machine 10 it is possible to perform numerous geometric measurements. For example, the test mandrel 27 can be moved along the longitudinal axis L to one or more contact locations K by means of the measuring disk 28, for example with the use of the Y-axis 12y. Subsequently, the test mandrel 27 can be rotated by a specified angle of rotation about the longitudinal axis L and be again moved to the same location along the longitudinal axis L by the measuring disk 28. In this manner, it is possible to determine the concentricity of the A-axis 12a.

It is also possible to determine the parallelity of the A-axis 12a relative to the X-axis 12x. With the use of the X-axis 12x, it is possible to bring the test mandrel 27 and the measuring disk 28 into contact at a contact location. Subsequently, the C-axis is rotated by a specified angle of rotation, preferably 180° and, again, a contact location between the test mandrel 27 and the measuring disk 28 is approached with the use of the X-axis 12x. Based on this, it is possible to determine axis parallelity. Analogous thereto, the parallelity of the A-axis 12a relative to the Z-axis 12z can be determined with the use of the Z-axis.

By moving over several contact locations K on the face 57 of the test mandrel 27 with the use of the Y-axis 12y, it is possible, for example, to determine the right angularity of the A-axis 12a relative to the Y-axis 12y. If the face 57 is too small for this, it is possible to use a disk electrically connected to ground M, instead of the test mandrel 27, as the first measuring body.

When the A-axis 12a is oriented parallel to the X-axis 12x, the axis of rotation R should bisect the longitudinal axis L. By moving to a contact location K at the intersection between the axis or rotation and the generated surface 56 of the test mandrel 27 in different rotary or swivel positions about the axis of rotation R, it is possible to determine a center offset between the axis of rotation R and the longitudinal axis L.

By means of the grinding and/or erosion machine described hereinabove, it is possible to perform additional gauging and referencing as desired. To do so, a sequence of contact locations K may be approached, respectively. For each contact location, a desired orientation of the longitudinal axis L relative to the spindle axis S may be specified. If, in addition to the C-axis 12c explained in accordance with the example, there are additional rotational machine axes, it is also possible to specify their angular positions for each position detection of a contact location K.

The described gauging or referencing operations may also be performed analogously with other axis arrangements. It depends on the respective specific axis arrangement whether or not the grinding spindle 13 is moved relative to the machine base 15 or the workpiece holding device 14 is moved relative to the machine base 15.

The invention relates to a grinding and/or erosion machine 10, as well as to a method for gauging and referencing the axis arrangement 11 comprising several machine axes 12, wherein each can be configured as a rotational or translational machine axis. To do so, a first measuring body (test mandrel 27) is inserted in a workpiece holding device 14 and a second measuring body (measuring disk 28) is inserted in a tool spindle 13. The test mandrel 27 is electrically connected to a reference potential, preferably ground M. The measuring disk 28 is electrically connected to a supply voltage potential UV. By forming a contact between the measuring disk 28 and the test mandrel 27, a measuring current IM flows between the supply voltage potential UV and the reference potential and, in accordance with the example, from the supply voltage potential UV to ground M. The flow of this measuring current IM may be detected in a monitoring device 31, and the actual position of the machine axes 12 at the time of the start of the current flow of the measuring current IM can be determined. Via the axis arrangement 11, one or more contact locations K between the measuring disk 28 and the test mandrel 27 can be approached, and, as a result of this, referencing or gauging of the axis arrangement 11 and the machine, respectively, can take place.

### LIST OF REFERENCE SIGNS

10 Grinding and/or erosion machine
11 Axis arrangement
12 Machine axis
12a A-axis
12c C-axis
12x X-axis
12y Y-axis
12z Z-axis
13 Tool spindle
14 Workpiece holding device
15 First slide
16 Second slide
17 Third slide
18 Carrier
19 Tool
20 Workpiece
21 Control device
22 Position detecting device
27 Test mandrel
28 Measuring disk
29 Isolation
30 Shaft section
31 Monitoring device
32 Monitoring unit
33 Connecting component
34 Counter-connecting component
35 First contact
36 Second contact
37 Third contact
38 First counter contact
39 Second counter contact
40 Third counter contact
41 Connecting line
42 First conductor
43 Monitoring component
44 Secondary circuit
45 Optical coupler
46 First monitoring input
49 Second conductor
50 Third conductor
51 Second monitoring input
54 Circumferential surface of the measuring disk
55 Lateral surface of the measuring disk
56 Generated surface of the test mandrel
57 Face of the test mandrel
IM Measuring current
K Contact location
L Longitudinal axis
M Ground
R Axis of rotation
S Spindle axis
US Secondary voltage potential
UV Supply voltage potential

1-16. (canceled)

17. A grinding and/or erosion machine comprising:
a tool spindle that can be driven about a spindle axis, said tool spindle being configured for the accommodation of a grinding or erosion tool;
a workpiece holding device being disposed for accommodating a workpiece;
a machine axis arrangement having several machine axes, said axis arrangement being configured for the rotational or translational movement or for the positioning of the tool spindle and/or the workpiece holding device;
a position detecting device, said device being configured for detecting the position of each of the present machine axes;
an electrically conductive first measuring body, said measuring body configured to be accommodated in the workpiece holding device, wherein the first measuring body can be connected to a specified reference potential;
an electrically conductive second measuring body configured to be accommodated in the tool spindle, wherein the second measuring body can be connected to a supply voltage potential and a monitoring device; and
a control device that is connected to the monitoring device and to the position detecting device and is configured to performing a method for gauging and/or referencing, comprising the following steps:
driving at least one machine axis in order to move the measuring bodies relative to each other and to bring them into contact with each other at a contact location, and
storing in memory the actual positions of the at least one driven machine axis when the monitoring device detects that, due to a contact, a measuring current flows between the measuring bodies.

18. The grinding and/or erosion machine according to claim 17, wherein the control device is configured to stop the driving of the at least one driven machine axis when the monitoring device detects that a measuring current flows due to a contact between the measuring bodies.

19. The grinding and/or erosion machine according to claim 17,
wherein the control device is configured to drive the at least one machine axis in such a manner that at least one present rotational machine axis displays a prespecified position of rotation at the time of contact between the measuring bodies at the contact location.

20. The grinding and/or erosion machine according to claim 17, wherein the second measuring body is configured as a measuring disk with a circumferential surface that is closed in a ring-shaped manner, said circumferential surface enclosing a lateral surface.

21. The grinding and/or erosion machine according to claim 20,
wherein the control device is configured to drive the at least one machine axis in such a manner that the measuring disk contacts the first measuring body with its circumferential surface or lateral surface.

22. The grinding and/or erosion machine according to claim 17, wherein the control device is configured to drive the at least one machine axis in such a manner that a sequence of different contact locations are successively reached.

23. The grinding and/or erosion machine according to claim 17, wherein the control device is configured to drive the at least one machine axis in such a manner that the number of successively reached contact locations corresponds to the number of those machine axes that are configured to change the relative position between the measuring bodies.

24. The grinding and/or erosion machine according to claim 17, wherein the monitoring device comprises a monitoring unit that is configured to monitor whether or not the second measuring body is electrically connected to the supply voltage potential.

25. The grinding and/or erosion machine according to claim 24, wherein the monitoring unit is a component of the control device or is communicationally connected to the control device, and that the control device is configured to drive the axis arrangement in a safety operation mode when the monitoring unit has detected the electrical connection between the second measuring body and the supply voltage potential.

26. The grinding and/or erosion machine according to claim 17, wherein the second measuring body is connected, via a connecting line, to a first contact of an electrical connecting component.

27. The grinding and/or erosion machine according to claim 26, wherein the electrical connecting component has a second contact and a third contact that are short-circuited with each other.

28. The grinding and/or erosion machine according to claim 17, further comprising an electrical counter-connecting component having a first counter contact, said counter contact being connected to the supply voltage potential by means of a first conductor via a monitoring component of the monitoring device.

29. The grinding and/or erosion machine according to claim 28, wherein the counter-connecting component has a second counter contact that is connected to the supply voltage potential by means of a second conductor, and wherein the counter-connecting component includes a third counter contact that is connected to a monitoring unit of the motoring device by means of a third conductor.

30. The grinding and/or erosion machine according to claim 28, wherein the second measuring body is connected, via a connecting line to a first contact of an electrical connecting component and wherein an electrical connection between the electrical connecting component and the counter-connecting component is established, such that the first contact is electrically connected to the first counter contact.

31. The grinding and/or erosion machine according to claim 29, wherein the second measuring body is connected, via a connecting line to a first contact of an electrical connecting component, wherein the electrical connecting component further includes a second contact and a third contact that are short-circuited with each other and wherein an electrical connection between the connecting component and the counter-connecting component is established, such that the second contact is electrically connected to the second counter contact, and also the third contact is electrically connected to the third counter contact.

32. A method for gauging and/or referencing a grinding and/or erosion machine, having a tool spindle that can be driven about a spindle axis, said tool spindle being configured for the accommodation of a grinding and erosion tool, a workpiece holding device configured for the accommodation of a workpiece, a machine axis arrangement having several machine axes, said axis arrangement being configured for the rotational or translational movement or positioning of the tool spindle and/or the workpiece holding device, a position detecting device configured for the detection of the position of each of the present machine axes, an electrically conductive first measuring body, an electrically conductive second measuring body, and a control device, wherein the method comprises:
inserting the first measuring body in the workpiece holding device;
electrically connecting the first measuring body to a defined reference potential;
inserting the second measuring body in the tool spindle;
electrically connecting the second measuring body to a supply voltage potential and a monitoring device;
driving at least one machine axis in order to move the measuring bodies relative to each other and to bring them into contact with each other at a contact location; and
storing in memory the actual position of the at least one driven machine axis when the monitoring device detects that, due to a contact, a measuring current flows between the measuring bodies.
